(19) United States
(12) Patent Application Publication
(10) Pub. No.: US 2006/0116140 A1
(43) Pub. Date: Jun. 1, 2006

(54) Method and apparatus for controlling state of multi-functional device using short message service, and multi-functional device including the apparatus

(75) Inventor: Kyoung-jae Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/267,151

(22) Filed: Nov. 7, 2005

(30) Foreign Application Priority Data
Nov. 30, 2004 (KR) 10-2004-0099044

(51) Int. Cl. H04Q 7/20

(52) U.S. Cl. 455/466

(57) ABSTRACT

A method and apparatus for controlling a system state of a multi-functional device or a printer based on the content of a short message provided via a short message service (SMS), and a multi-functional device using the apparatus are provided. The method includes steps for receiving a short message, verifying that the short message is from a subscriber authorized to change a state of the multi-functional device, and then controlling the state of the multi-functional device according to content for changing the state of the multi-functional device, which is included in the short message.

### CROSS-REFERENCE TO RELATED APPLICATIONS

This application claims the benefit under 35 U.S.C. §119(a) of Korean Patent Application No. 10-2004-0099044, filed in the Korean Intellectual Property Office on Nov. 30, 2004, the entire disclosure of which is incorporated herein by reference.

### FIELD OF THE INVENTION

The present invention relates to a multi-functional device or a printer having a facsimile (or fax) function. More particularly, the present invention relates to a method and apparatus for controlling a system state of a multi-functional device or printer based on the content of a short message provided via a short message service (SMS), and a multi-functional device using the apparatus.

### DESCRIPTION OF THE RELATED ART

With the development of office automation, the demand for office automation equipment such as copiers, printers, scanners, and fax machines has rapidly increased. In accordance with this trend, multiple function office automation equipment has been developed to achieve such demanded high performance. In addition, products having multiple document output functions, in which a number of independent office automation devices are integrated, thereby decreasing the financial burden and required installation space, have been manufactured and provided. Such products are referred to as multi-functional devices (MFDs). That is, MFDs typically have multiple document output functions such as a printer function that prints data input from a host computer, a scanner function that reads image documents, a copier function that copies image documents input through scanning, and a fax function that transmits image documents to a remote location through a communication line. Such MFDs are comprised of terminals such as a fax, scanner, printer, and copier, which usually exist independently, and usually have a host computer interface function to connect the MFD to a host computer.

Recently, MFDs having an SMS function have become widely available. For example, Korean Patent Publication No. 2003-93767, the entire disclosure of which is hereby incorporated by reference, discloses an MFD including a fax which has an SMS function, and a method of printing a fax image using the MFD including the fax.

Conventionally, MFDs having an SMS function simply receive a short message and store it in memory or print it out, but do not provide a function by which a system state can be changed using a SMS. For example, conventional MFDs cannot be turned on or off, or cannot be set to forward a fax to a user in his/her office using a SMS.

Accordingly, a need exists for a system and method for controlling a system state of a multi-functional device based on the content of a short message provided via a short message service.

### SUMMARY OF THE INVENTION

Embodiments of the present invention substantially solve the above and other problems, and provide a method of controlling the state of a multi-functional device (MFD) using a short message service (SMS) to input a state or change the state of the MFD.

Embodiments of the present invention further provide an apparatus for controlling the state of an MFD using a SMS to input a state or change the state of the MFD.

Embodiments of the present invention still further provide an MFD including an apparatus for controlling the state of the MFD using a SMS to input or change the state of the MFD.

According to an aspect of the present invention, a method of controlling a state of a multi-functional device using a SMS is provided, comprising the steps of receiving a short message, and controlling the state of the multi-functional device according to content for changing the state of the multi-functional device, which is included in the short message.

The method may further comprise the step of determining whether the short message satisfies a requirement for changing the state of the multi-functional device.

According to another aspect of the present invention, an apparatus for controlling a state of a multi-functional device using a SMS is provided, comprising a receiving unit for receiving a short message, and a control unit for controlling the state of the multi-functional device according to content for changing the state of the multi-functional device, which is included in the short message.

The apparatus may further comprise a determination unit for determining whether the short message satisfies a requirement for changing the state of the multi-functional device.

According to still another aspect of the present invention, an MFD including an apparatus for controlling a state of a multi-functional device using a SMS is provided.

### BRIEF DESCRIPTION OF THE DRAWINGS

The above and other features and advantages of the present invention will become more apparent by describing in detail exemplary embodiments thereof with reference to the attached drawings, in which:

FIG. 1 is a flowchart of a method of controlling the state of a multi-functional device (MFD) using a short message service (SMS) according to an embodiment of the present invention;

FIG. 2 is a block diagram of an apparatus for controlling the state of an MFD using a SMS according to an embodiment of the present invention;

FIG. 3 is a block diagram of an MFD according to an embodiment of the present invention;

FIG. 4 is a flowchart of a method for controlling the state of an MFD using a SMS according to an embodiment of the present invention;

FIG. 5 illustrates a screen displayed message allowing a calling subscriber number to be input according to an embodiment of the present invention;

FIG. 6 illustrates a screen displayed message allowing a secret number to be input according to an embodiment of the present invention;

FIG. 7 illustrates the content of a displayed message transmitted to change an answer mode into a fax mode according to an embodiment of the present invention;

FIG. 8 illustrates the content of a displayed message transmitted to set a fax forwarding function according to an embodiment of the present invention;

FIG. 9 illustrates the content of a displayed message transmitted to register a speed dial number according to an embodiment of the present invention; and

FIG. 10 illustrates the content of a displayed message transmitted to turn off the power of an MFD according to an embodiment of the present invention.

Throughout the drawings, like reference numerals will be understood to refer to like parts, components and structures.

### DETAILED DESCRIPTION OF THE EXEMPLARY EMBODIMENTS

Hereinafter, a number of exemplary embodiments of the present invention will be described in detail with reference to the attached drawings.

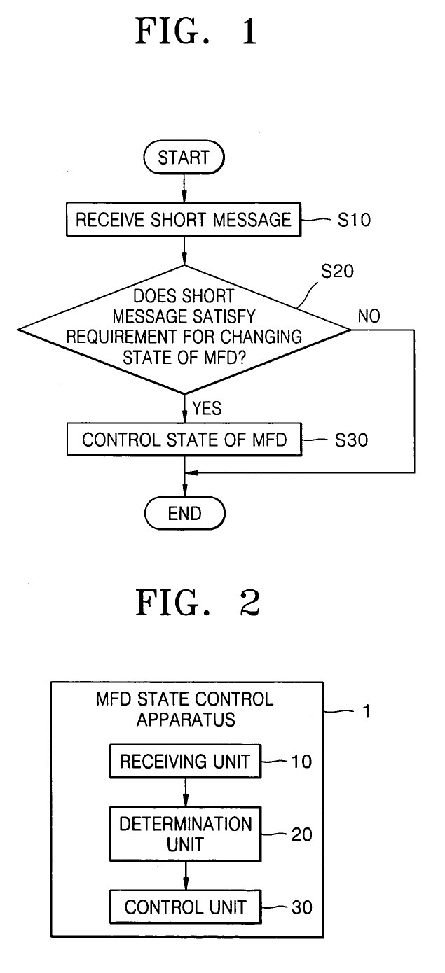

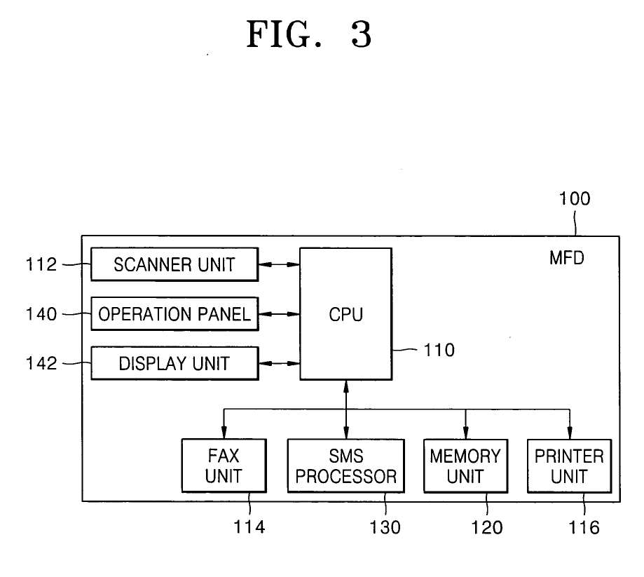

FIG. 1 is a flowchart of a method of controlling the state of a multi-functional device (MFD) using a short message service (SMS) according to an embodiment of the present invention. Referring to FIG. 1, in operation S10, a short message according to a SMS is received. In operation S20, it is determined whether the short message satisfies a requirement for changing the state of the MFD. An exemplary MFD is shown in FIG. 3 and described in greater detail below. If it is determined that the short message does not satisfy the requirement, the method ends.

However, if it is determined that the short message satisfies the requirement, the state of the MFD is controlled according to the content of the short message in operation S30.

Operation S20 may, for example, comprise an operation for determining whether a calling subscriber number corresponding to the short message is authorized to change the state of the MFD, and determining that the short message does not satisfy the requirement if it is determined that the calling subscriber number is not authorized. A calling subscriber number that is authorized to change the state of the MFD can be input to and stored in the MFD by a user in advance.

Alternatively, operation S20 may comprise an operation for determining whether the short message includes a character and number for changing the state of the MFD, and determining that the short message does not satisfy the requirement if it is determined that the short message does not include the character and number. It is preferable that operation S20 comprise an operation for determining whether the short message begins with a special character for changing the state of the MFD, and further includes a secret number that can be input to and stored in the MFD by a user in advance. In this case, if the short message does not include the special character and the secret number, it is determined that the short message does not satisfy the requirement for changing the state of the MFD in operation S20.

Operation S30 may comprise an operation for controlling the power of the MFD to be turned on or off when the short message includes instructions to turn the power on or off, respectively. Operation S30 may also comprise an operation for controlling an answer mode of the MFD to be converted into a fax mode when the short message includes instructions to convert the answer mode of the MFD into the fax mode. In addition, operation S30 may comprise an operation for controlling a fax forwarding function of the MFD to be executed when the short message includes instructions to execute the fax forwarding function of the MFD. Moreover, operation S30 may comprise an operation for controlling a speed dial number to be registered in the MFD when the short message includes instructions to register the speed dial number in the MFD.

FIG. 2 is a block diagram of an apparatus for controlling the state of an MFD using a SMS (hereinafter, referred to as an MFD state control apparatus 1) according to an embodiment of the present invention. Referring to FIG. 2, the MFD state control apparatus 1 comprises a receiving unit 10, a determination unit 20, and a control unit 30.

The receiving unit 10 receives a short message. The determination unit 20 determines whether the short message satisfies a requirement for changing the state of the MFD. If it is determined that the short message satisfies the requirement for changing the state of the MFD, the control unit 30 controls the state of the MFD according to the content of the short message.

The determination unit 20 may, for example, be configured to determine whether a calling subscriber number corresponding to the short message is authorized to change the state of the MFD, and determine that the short message does not satisfy the requirement if it is determined that the calling subscriber number is not authorized. Here, a calling subscriber number authorized to change the state of the MFD can be input to and stored in the MFD by a user in advance.

Alternatively, the determination unit 20 may be further configured to determine whether the short message includes a character and number for changing the state of the MFD, and determine that the short message does not satisfy the requirement if it is determined that the short message does not include the character and number. As another alternative, the determination unit 20 may be further configured to determine whether the short message begins with a special character for changing the state of the MFD, and further includes a secret number that can be input to and stored in the MFD by a user in advance. In this case, if the short message does not include the special character and the secret number, the determination unit 20 may be configured to determine that the short message does not satisfy the requirement for changing the state of the MFD.

The control unit 30 may, for example, be configured to control the power of the MFD to be turned on or off when the short message includes instructions to turn the power on or off, respectively. The control unit 30 may also be configured to control an answer mode of the MFD to be converted into a fax mode when the short message includes instructions to convert the answer mode of the MFD into the fax mode. In addition, the control unit 30 may be further configured to control a fax forwarding function of the MFD to be executed when the short message includes instructions to execute the fax forwarding function of the MFD. Moreover, the control unit 30 may be further configured to control a speed dial number to be registered in the MFD when the short message includes instructions to register the speed dial number in the MFD.

The MFD state control apparatus 1 illustrated in FIG. 2 can be provided separately, or can be included in an MFD. For example, FIG. 3 is a block diagram of an MFD 100 according to an embodiment of the present invention, which can include the MFD state control apparatus of FIG. 2. The MFD 100 comprises a central processing unit (CPU) 110, a scanner unit 112, a fax unit 114, a printer unit 116, a memory unit 120, an SMS processor 130, an operation panel 140, and a display unit 142.

The CPU 110 controls the MFD 100 according to a predetermined program. The memory unit 120 stores an operating program for the CPU 110, a general control program, and SMS data received through the SMS processor 130. In addition, image data scanned by the scanner unit 112 and fax data input through the fax unit 114, are stored in the memory unit 120. The printer unit 116 prints data stored in the memory unit 120 or data received from a printer driver of a host computer (not shown).

The operation panel 140 is comprised of a plurality of keys (not shown) and applies key data generated by pressing a key, to the CPU 110. The operating state of the MFD 100 is displayed on the display unit 142, which is comprised of a liquid crystal display (LCD) or a light emitting diode (LED), according to display data from the CPU 110.

The CPU 110 analyzes a received short message to determine whether the short message is for changing the state of the MFD 100, controls the state of the MFD 100 to be changed when the short message satisfies a requirement for changing the state of the MFD 100, and stores the short message in the memory unit 120 when the short message does not satisfy the requirement.

FIG. 4 is a flowchart of a method for controlling the state of an MFD using a SMS according to an embodiment of the present invention. Referring to FIG. 4, in operation S100, it is determined whether a short message has been received. If it is determined that a short message has not been received, the method ends.

If it is determined that a short message has been received, in operation S102 it is then determined whether a calling subscriber number corresponding to the received short message is authorized to change the state of the MFD. If it is determined that the calling subscriber number is not authorized, in operation S108 the short message is determined to be a usual message and is stored in the memory unit 120.

If it is determined that the calling subscriber number is authorized, it is determined whether the short message satisfies a requirement for changing the state of the MFD. For example, in operation S104, it is determined whether the short message begins with a predetermined character or number for changing the state of the MFD. If it is determined that the short message begins with the predetermined character or number, in operation S106 the short message is analyzed and the state of the MFD is changed according to the content of the short message.

If it is determined that the short message does not begin with the predetermined character or number, in operation S108 the short message is determined to be a usual message and is stored in the memory unit 120.

As described above, if a sender of a short message does not have authority to change the state of an MFD or if the short message does not satisfy a requirement for changing the state of an MFD, the short message does not affect the state of the MFD, and it is determined to be a usual message and is stored in a memory unit.

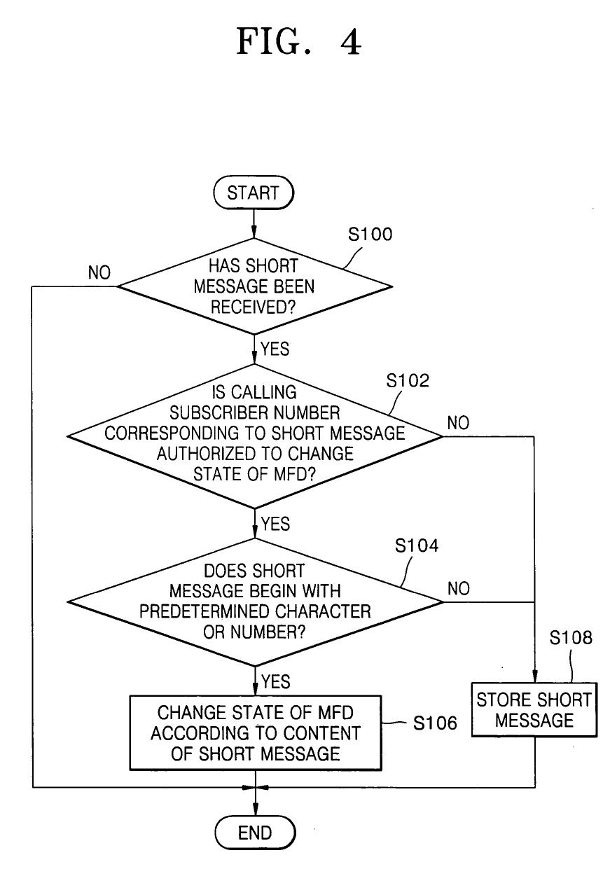

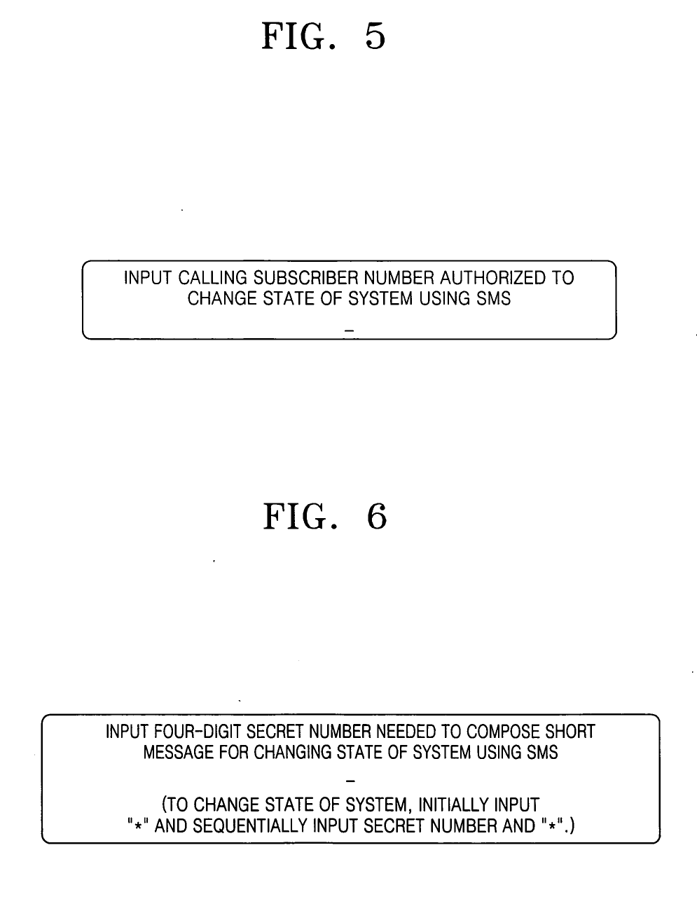

According to embodiments of the present invention, an MFD or a printer with a function that receives a message sent using a SMS can analyze a short message having a predetermined format and change the state of a system. For these operations, a user preferably inputs to the MFD 100 a calling subscriber number that is authorized to change the state of a system, and stores the calling subscriber number in the memory unit 120 in advance. FIG. 5 illustrates a screen displayed message on the display unit 142, such as an LCD, of the MFD 100 to allow a user to input a calling subscriber number that is authorized to change the state of a system. The inputting of an authorized calling subscriber number is provided to prevent an unauthorized person from changing the state of the system using a SMS, thereby ensuring security.

In addition, if a secret number is used, the user of the MFD 100 preferably inputs the secret number used to change the state of the system into the MFD 100, and stores the secret number in the memory unit 120 in advance. FIG. 6 illustrates a screen displayed message on the LCD of the MFD 100 to allow the user to input the secret number.

In this situation, when the MFD 100 receives a short message, it can be determined whether the short message is for changing the state of the system by verifying the secret number included in the short message. When the secret number is verified, the content of the short message following the secret number is analyzed and the state of the system is changed. For example, an input rule can be set to require that a user initially input “*”, then input a secret number, and then input “*” when the user composes a short message using a mobile phone in order to indicate that the short message is for changing the state of the system.

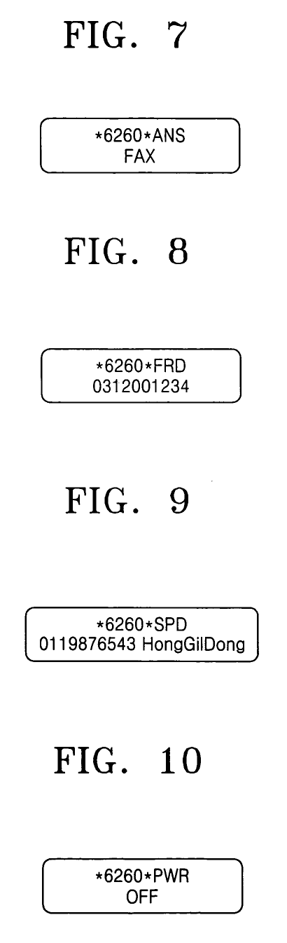

An example of changing the state of a system using a SMS according to an embodiment of the present invention is described in greater detail below with reference to FIGS. 7 through 10.

FIG. 7 illustrates the content of a short message input to a mobile phone by a user to change an answer mode of an MFD into a fax mode according to an embodiment of the present invention. When the user is at a location remote from an MFD and needs to receive a fax in the MFD, which has a telephone function and fax function and has been set to a telephone mode as an answer mode, the user can change the answer mode into the fax mode by transmitting a short message as shown in FIG. 7 to the MFD using a SMS. In this example, the user inputs “*”, then inputs a secret number “6260”, and then inputs “*” in order to indicate that the short message is for changing the state of the system. The user then inputs “ANS FAX” to change the answer mode into the fax mode. In these examples, the secret number 6260 is presented as an example only.

FIG. 8 illustrates the content of a short message input to a mobile phone by a user to set a fax forwarding function in an MFD according to an embodiment of the present invention. For example, when an urgent and important fax will be received in the MFD at the user's home and the user wants to receive the fax at the user's office through fax forwarding, the user can set the fax forwarding function and a number of a fax machine at the user's office to which the fax is to be forwarded, in the MFD at home by transmitting a short message as shown in FIG. 8 to the MFD at home using a SMS. In this example, the user inputs “*”, then inputs a secret number “6260”, and then inputs “*” in order to indicate that the short message is for changing the state of the system. The user then inputs “FRD 0312001234” to set the fax forwarding function and a number of a fax machine at the user's office.

FIG. 9 illustrates the content of a short message input to a mobile phone by a user to register a new speed dial number in an MFD according to an embodiment of the present invention. The user at a remote location can register a telephone number as a speed dial number in the MFD by transmitting a short message as shown in FIG. 9 to the MFD using a SMS. In this example, the user inputs “*”, then inputs a secret number “6260”, and then inputs “*” in order to indicate that the short message is for changing the state of the system. The user then inputs “SPD 0119876543 HongGilDong” to register a telephone number as a speed dial number in the MFD.

FIG. 10 illustrates the content of a short message input to a mobile phone by a user to turn off the power of an MFD according to an embodiment of the present invention. The user at a remote location can turn off the power of the MFD to reduce power consumption by transmitting a short message shown in FIG. 10 to the MFD using a SMS. In this example, the user inputs “*”, then inputs a secret number “6260”, and then inputs “*” in order to indicate that the short message is for changing the state of the system. The user then inputs “PWR OFF” to turn off the power of the MFD.

As described above, according to embodiments of the present invention, the state of an MFD or a printer can be changed at a remote location using a SMS. Accordingly, since the power of the MFD can be turned off, power consumption can be reduced. In addition, according to embodiments of the present invention, an urgent fax can be acquired in a location remote from the MFD through fax forwarding. Moreover, a user can easily input data such as a speed dial number including a character and number into the MFD using a SMS.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. A method of controlling a state of a multi-functional device using a short message service, the method comprising the steps of:
receiving a short message comprising instructions for changing the state of a multi-functional device; and
controlling the state of the multi-functional device according to the instructions for changing the state of the multi-functional device included in the short message.

2. The method of claim 1, further comprising the step of:
determining whether the short message satisfies a requirement for changing the state of the multi-functional device, wherein the controlling of the state is performed when the short message satisfies the requirement.

3. The method of claim 2, wherein the step of determining whether the short message satisfies a requirement comprises the steps of:
determining whether a calling subscriber number corresponding to the short message is authorized to change the state of the multi-functional device; and
determining that the short message does not satisfy the requirement when the calling subscriber number is not authorized.

4. The method of claim 3, further comprising the steps of:
inputting and storing a calling subscriber number that is authorized to change the state of the multi-functional device in the multi-functional device in advance.

5. The method of claim 2, wherein the step of determining whether the short message satisfies a requirement comprises the steps of:
determining whether the short message comprises a character and number for changing the state of the multi-functional device; and
determining that the short message does not satisfy the requirement when the short message does not comprise the character and number.

6. The method of claim 5, wherein the step of determining whether the short message comprises the character and number comprises the step of:
determining whether the short message begins with a special predetermined character for changing the state of the multi-functional device and further comprises a secret number, wherein the secret number can be input to and stored in the multi-functional device in advance.

7. The method of claim 1, wherein the step of controlling the state of the multi-functional device comprises the step of:
controlling the power of the multi-functional device to be turned off when the short message comprises instructions to turn off the power.

8. The method of claim 1, wherein the step of controlling the state of the multi-functional device comprises the step of:
controlling an answer mode of the multi-functional device to be converted into a fax mode when the short message comprises instructions to convert the answer mode of the multi-functional device into the fax mode.

9. The method of claim 1, wherein the step of controlling the state of the multi-functional device comprises the step of:
controlling a fax forwarding function of the multi-functional device to be executed when the short message comprises instructions to execute the fax forwarding function of the multi-functional device.

10. The method of claim 1, wherein the step of controlling the state of the multi-functional device comprises the step of:
controlling a speed dial number to be registered in the multi-functional device when the short message comprises instructions to register the speed dial number in the multi-functional device.

11. An apparatus for controlling a state of a multi-functional device using a short message service, the apparatus comprising:
a receiving unit for receiving a short message comprising instructions for changing the state of a multi-functional device; and
a control unit for controlling the state of the multi-functional device according to the instructions for changing the state of the multi-functional device included in the short message.

12. The apparatus of claim 11, further comprising:
a determination unit for determining whether the short message satisfies a requirement for changing the state of the multi-functional device, wherein the control unit is configured to control the state of the multi-functional device according to the instructions for changing the state of the multi-functional device when the determination unit determines that the short message satisfies the requirement.

13. The apparatus of claim 12, wherein the determination unit is configured to determine whether a calling subscriber number corresponding to the short message is authorized to change the state of the multi-functional device and determine that the short message does not satisfy the requirement when the calling subscriber number is not authorized.

14. The apparatus of claim 13, wherein a calling subscriber number that is authorized to change the state of the multi-functional device is input to and stored in the multi-functional device in advance.

15. The apparatus of claim 12, wherein the determination unit is configured to determine whether the short message comprises a character and number for changing the -state of the multi-functional device and determine that the short message does not satisfy the requirement when the short message does not comprise the character and number.

16. The apparatus of claim 15, wherein the determination unit is configured to determine whether the short message begins with a special predetermined character for changing the state of the multi-functional device and further comprises a secret number, wherein the secret number can be input to and stored in the multi-functional device in advance.

17. The apparatus of claim 11, wherein the control unit is configured to control the power of the multi-functional device to be turned off when the short message comprises instructions to turn off the power.

18. The apparatus of claim 11, wherein the control unit is configured to control an answer mode of the multi-functional device to be converted into a fax mode when the short message comprises instructions to convert the answer mode of the multi-functional device into the fax mode.

19. The apparatus of claim 11, wherein the control unit is configured to control a fax forwarding function of the multi-functional device to be executed when the short message comprises instructions to execute the fax forwarding function of the multi-functional device.

20. The apparatus of claim 11, wherein the control unit is configured to control a speed dial number to be registered in the multi-functional device when the short message comprises instructions to register the speed dial number in the multi-functional device.

21. A multi-functional device having at least one of a printer function that prints data input from a host computer, a scanner function that reads image documents, a copier function that copies image documents input through scanning, and a fax function that transmits image documents to a remote location through a communication line, the device comprising:
a receiving unit for receiving a short message comprising instructions for changing the state of a multi-functional device; and
a control unit for controlling the state of the multi-functional device according to the instructions for changing the state of the multi-functional device included in the short message.

22. The multi-functional device of claim 21, further comprising:
a determination unit for determining whether the short message satisfies a requirement for changing the state of the multi-functional device, wherein the control unit is configured to control the state of the multi-functional device according to the instructions for changing the state of the multi-functional device when the determination unit determines that the short message satisfies the requirement.

23. The multi-functional device of claim 22, wherein the determination unit is configured to determine whether a calling subscriber number corresponding to the short message is authorized to change the state of the multi-functional device and determine that the short message does not satisfy the requirement when the calling subscriber number is not authorized.

24. The multi-functional device of claim 23, wherein a calling subscriber number that is authorized to change the state of the multi-functional device is input to and stored in the multi-functional device in advance.

25. The multi-functional device of claim 22, wherein the determination unit is configured to determine whether the short message comprises a character and number for changing the state of the multi-functional device and determine that the short message does not satisfy the requirement when the short message does not comprise the character and number.

26. The multi-functional device of claim 25, wherein the determination unit is configured to determine whether the short message begins with a special predetermined character for changing the state of the multi-functional device and further comprises a secret number, wherein the secret number can be input to and stored in the multi-functional device in advance.

27. The multi-functional device of claim 21, wherein the control unit is configured to control the power of the multi-functional device to be turned off when the short message comprises instructions to turn off the power.

28. The multi-functional device of claim 21, wherein the control unit is configured to control an answer mode of the multi-functional device to be converted into a fax mode when the short message comprises instructions to convert the answer mode of the multi-functional device into the fax mode.

29. The multi-functional device of claim 21, wherein the control unit is configured to control a fax forwarding function of the multi-functional device to be executed when the short message comprises instructions to execute the fax forwarding function of the multi-functional device.

30. The multi-functional device of claim 21, wherein the control unit is configured to control a speed dial number to be registered in the multi-functional device when the short message comprises instructions to register the speed dial number in the multi-functional device.
